(19) United States
(12) Patent Application Publication
(10) Pub. No.: US 2014/0069942 A1
(43) Pub. Date: Mar. 13, 2014

(54) PLASTIC CONTAINER WITH REINFORCED STRUCTURE

(71) Applicant: IPL, Inc., St-Damien (CA)

(72) Inventors: Frederic Duquenoy, Saint-Romuald (CA); Marc Talbot Pouliot, Saint-Lazare (CA)

(73) Assignee: IPL, Inc., St-Damien (CA)

(21) Appl. No.: 14/018,921

(22) Filed: Sep. 5, 2013

Related U.S. Application Data
(60) Provisional application No. 61/698,132, filed on Sep. 7, 2012.

(51) Int. Cl. B65D 1/46; B29D 22/00

(52) U.S. Cl. CPC B65D 1/46; B29D 22/003
USPC 220/675; 264/328.1

(57) ABSTRACT

A container and a method of fabrication thereof, the container comprising a base; a plurality of sidewalls extending from the base to a top opening, adjacent sidewalls being connected together by a corner; a plurality of flow leaders extending across the base, each flow leader extending along a surface of a respective sidewall up to a distance from the top opening, each flow leader having a thickness greater than a wall thickness of the base and a wall thickness of the respective sidewall; and a plurality of corner portions extending along a height of a respective corner, the corner portion increasing a wall thickness of each corner to a wail thickness substantially greater than the wall thickness of the sidewalls.

### CROSS REFERENCE TO RELATED APPLICATIONS

This application claims benefit of U.S. provisional application Ser. No. 61/698,132, filed on Sep. 7, 2012. All documents above are incorporated herein in their entirety by reference.

### FIELD OF THE INVENTION

The present invention relates to plastic containers and a method of fabrication thereof. More specifically, the present invention is concerned with plastic containers made of a reduced amount of material and a method of fabrication thereof.

### BACKGROUND OF THE INVENTION

Plastic pails are desired because they are lightweight and rugged, able to be used in a variety of industrial and home uses.

There is great concern these days for “carbon footprint”, about the cost of shipping and the cost of the starting material. Therefore, it is desirous to construct plastic pails utilizing less material, resulting in reduced amount of starting material, reduced weight of the finished pails and reduced cost of shipping. In this way, fewer plastic starting materials are used, less energy may be required in manufacture and as a result of the lesser weight, less energy and overall cost is involved with shipment.

Many pails have been designed to increase structural integrity thereof. For example, pails have been created with concave walls. These have been satisfactory; however they require reinforcing ribs, and/or complex mesh structures, as known for example from U.S. Published Application No. 2009/0152280. As a result, the manufacture of the pail becomes overly complex, or requires additional material, thereby increasing the carbon footprint and the overall weight.

There is still a need in the art for plastic containers made of a reduced amount of material and a method of fabrication thereof.

The present description refers to a number of documents, the content of which is herein incorporated by reference in their entirety.

### SUMMARY OF THE INVENTION

More specifically, in accordance with the present invention, there is provided a container, comprising abase; a plurality of sidewalls extending from the base to a top opening, adjacent sidewalls being connected together by a corner; a plurality of flow leaders extending across the base, each flow leader extending along a surface of a respective sidewall up to a distance from the top opening, each flow leader having a thickness greater than a wall thickness of the base and a wall thickness of the respective sidewall; and a plurality of corner portions extending along a height of a respective corner, the corner portion increasing a wall thickness of each corner to a wall thickness substantially greater than the wall thickness of the sidewalls.

There is provided a method for molding a container, comprising providing a flow leader along a base and each sidewall of a mold along a height of each sidewall from the base; providing a thickness portion at each corner of the mold; and injecting plastic into the mold.

There is provided a method of forming a container, comprising forming a base; forming sidewalls extending from the base; forming corners connecting adjacent sidewalls, each corner having at least one part of a height thereof of an increased thickness relative to a wall thickness of the sidewalls; and providing flow leaders extending across the base, each flow leader extending up along a surface of a respective sidewall, each flow leader having a thickness greater than a wall thickness of the base and a wall thickness of the respective sidewall.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a top perspective view of a container according to an embodiment of an aspect of the present invention;

FIG. 2 is a corner top perspective view of the container of FIG. 1;

FIG. 3 is a top perspective view of the container of FIG. 1;

FIG. 4 is a bottom plan view of FIG. 1;

FIG. 5 is a perspective view of the top portion of the container of FIG. 1;

FIG. 6 is a side plan view of the container of FIG. 1;

FIG. 7 is a sectional view taken along line 7-7 of FIG. 4; and

FIG. 8 is a sectional view taken along line 8-8 of FIG. 6.

### DESCRIPTION OF ILLUSTRATIVE EMBODIMENTS

The present invention is illustrated in further details by the following non-limiting examples.

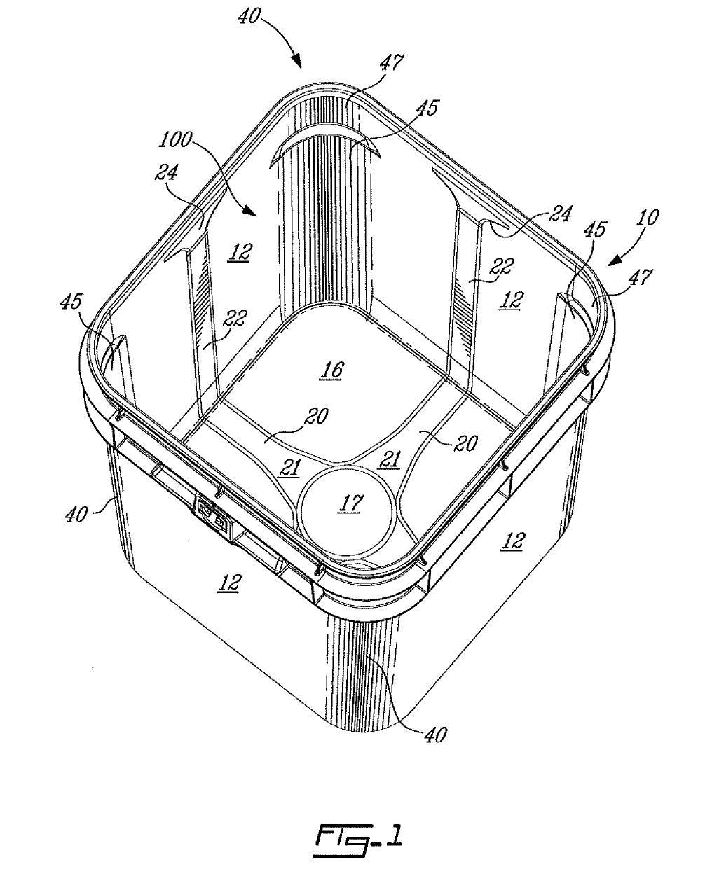

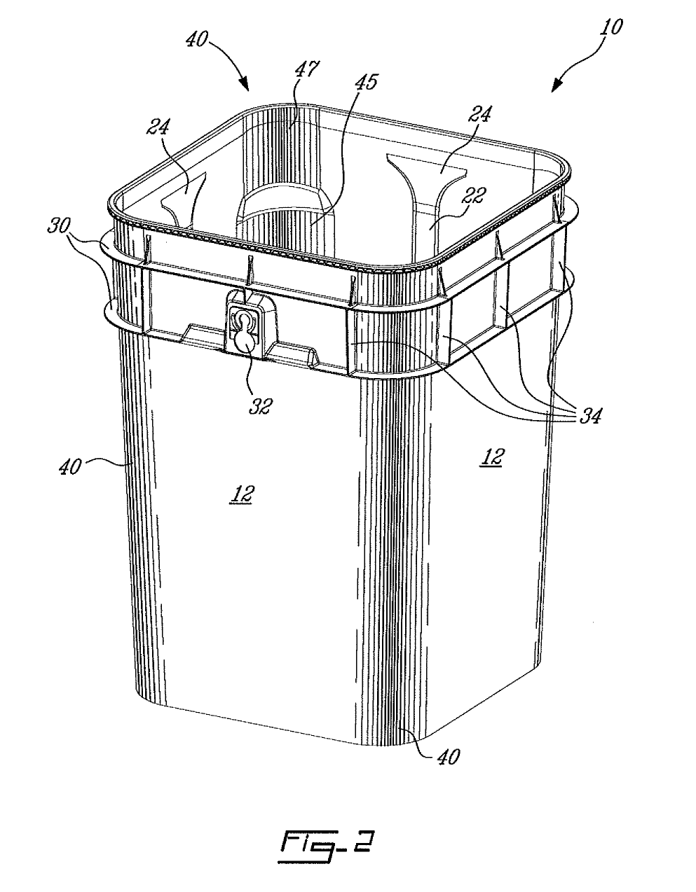

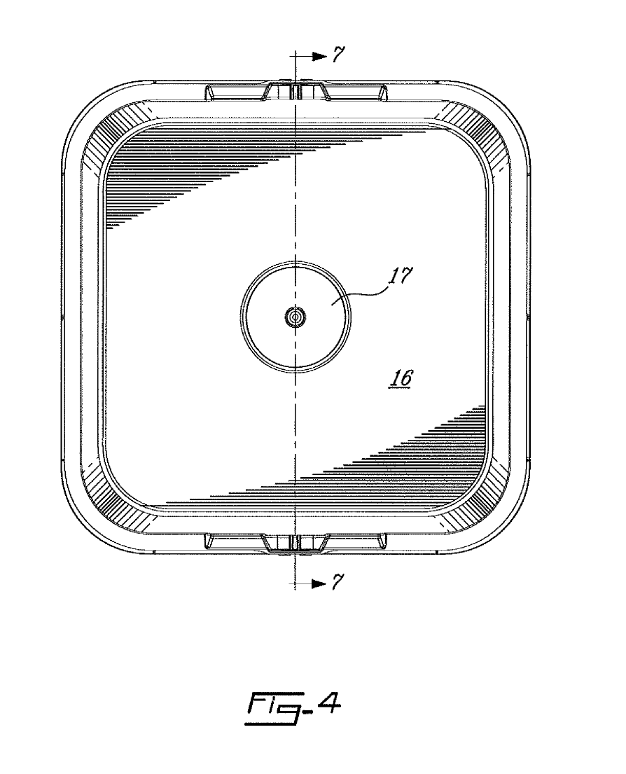

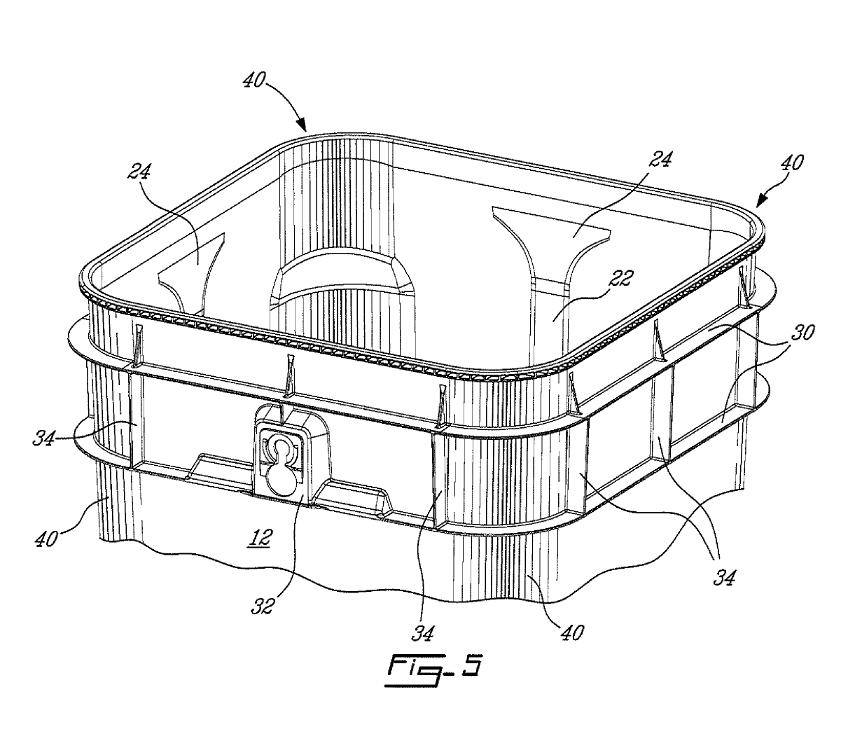

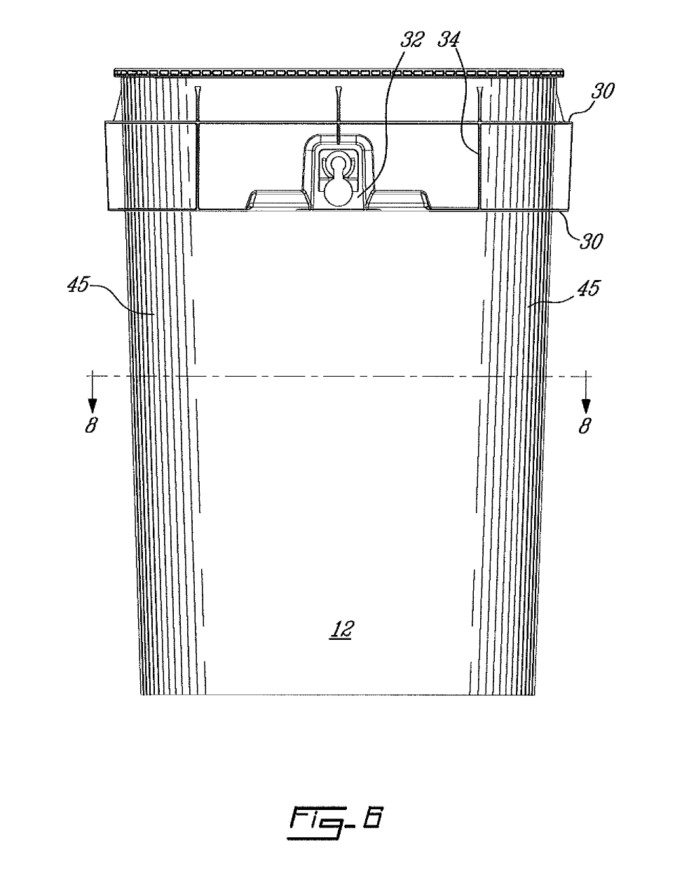

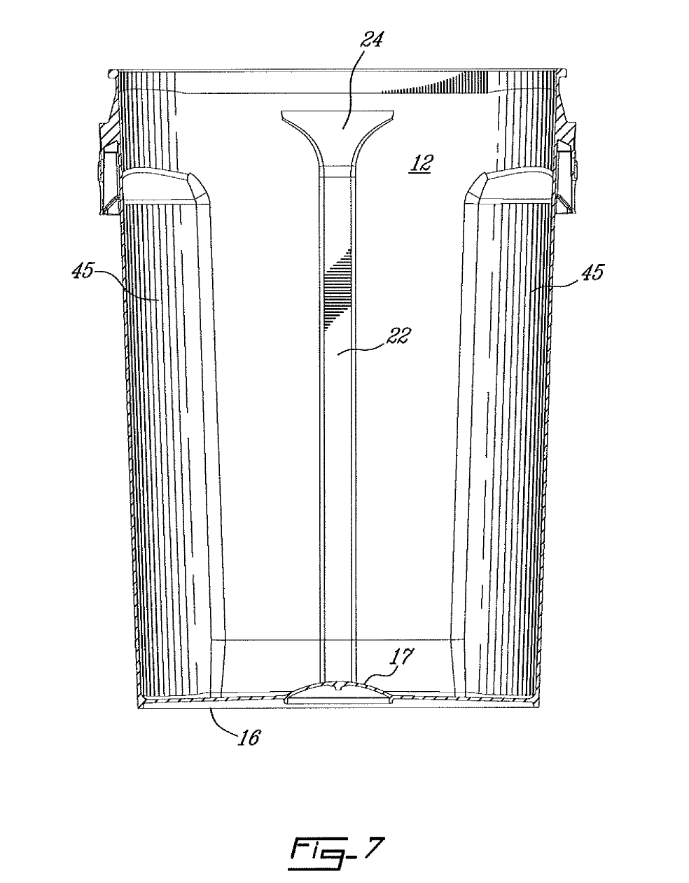

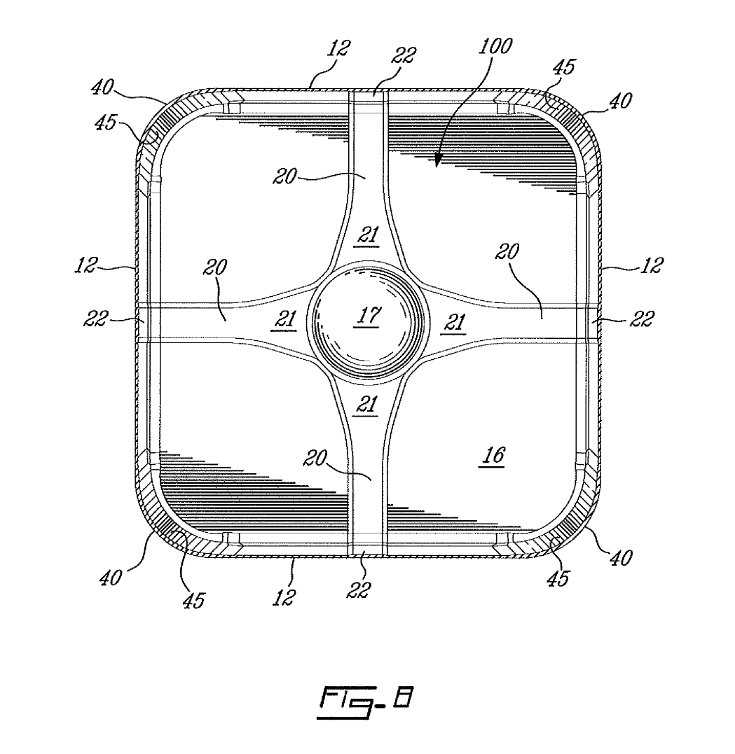

In an embodiment illustrated for example in FIGS. 1-8, a container, generally indicated as 10, includes a base 16 and side walls 12 extending upwardly from the base 16 to a top opening. Adjacent sidewalls 12 extend into each other in rounded corners 40, thereby forming an enclosed internal cavity 100.

At least one horizontal rib, or a skirt, may be provided about at least part of the upper portions of sidewalls 12, Spaced horizontal ribs 30 are shown extending about the upper portions of sidewalls 12 in the figures. Handle receiving members 32 may be positioned between ribs 30 at opposed sides of container 10, and handles (not shown) may be received within the handle receiving portions 32, as known in the art.

Vertical ribs 34 extend along part of the height of the container, at upper portions of sidewalls 12. Vertical ribs 34 are shown at spaced intervals between horizontal ribs 30 in the figures.

Horizontal spaced ribs 30 as well as vertical ribs 34 contribute to the structural integrity and maintain the shape of the container 10.

The base 16, sidewalls 12, corners 40, horizontal ribs 30, and vertical ribs 34 may be formed as a one-piece by injection molding from a single injection point for example (see gate site 17).

In the illustrated embodiment, the container 10 has a substantially squarish or rectangular footprint. Sidewalls 12 may be slightly tapered to promote nesting, so that a lower rib 30 (relative to the base 16), of a pair of horizontal ribs 30 for example, can act as a stop to prevent overinsertion of a top container 10 into a bottom container 10 upon stacking containers for example, vertical ribs 34 preventing stacked containers from getting jammed and stuck together when stacked.

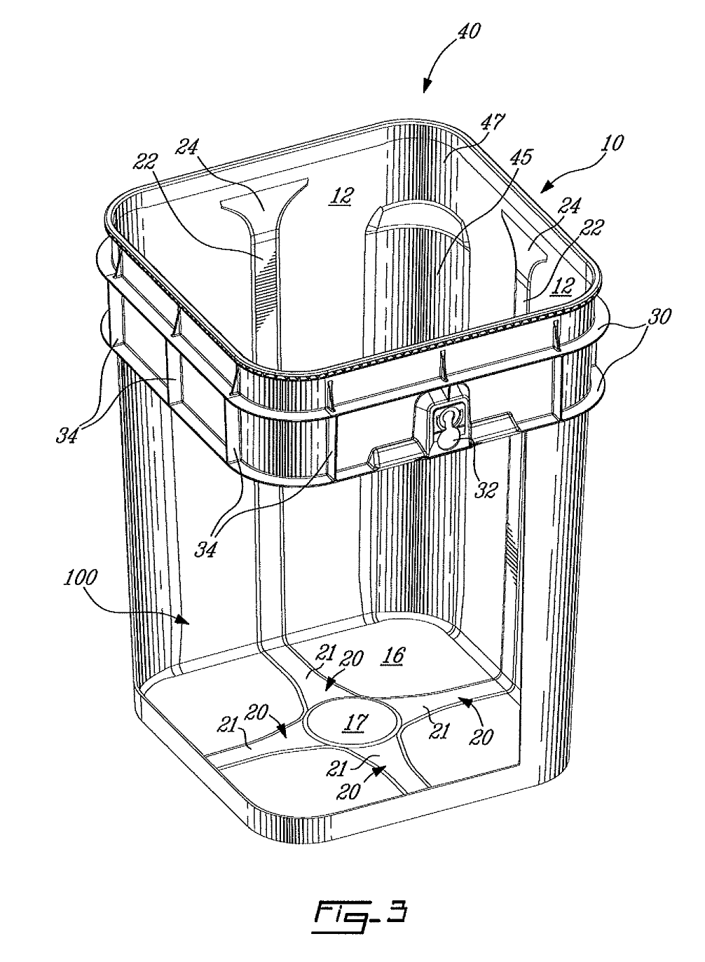

The base 16 comprises a gate site 17, flow leaders 20 extending from the gate site 17 to a respective sidewall 12, by way of flow leader sections 21. In an embodiment, each flow leader 20 continue to a beam section 22 extending along an interior surface of each sidewall 12, i.e. facing the internal cavity 100 of the container 10, and, in a non-limiting, but exemplary embodiment, terminating in a flare or plume section 24 in an upper part of each sidewall 12. In the illustrated embodiment, the flow leader sections 21 on the base 16 are disposed at about a 90 degree angle from one another, as shown for example in FIGS. 1 and 3. Flow leader sections 21, 22, 24 make up a continuous flow leader 20 from the gate site 17 and provide structural integrity to sidewalls 12 without the need for an additional web structure. While the flow leader sections 21 are shown provided on the interior of the container 10, i.e. facing the internal cavity 100 of the container 10, they could also be disposed on an exterior surface of the container 10. In case of a container with a substantially triangular footprint for example, flow leader sections would be extending on the base 16 from the gate site 17 to each respective one of three sidewalls.

In one non-limiting embodiment, the flow leader sections 21 taper, from the gate site 17, down to a width of at least about ½ inch, for example comprised between about ½ inch and about 1½ inches, for example to a width of about ¾ inch, and the flow leader sections 20 substantially maintain that width along the beam sections 22 as the beam sections 22 extend up their respective sidewall 12, until each beam section 22 flares at its respective flare or plume section 24 if any, as described hereinabove. The thickness of the flow leaders 20 is larger than the thickness of the base 16 and the thickness of the sidewalls 12. The thickness of the flow leaders 20 is selected to increase the wall thickness of the sidewalls 12 or of the base 16, by about 10 to 50 percent. For a typical wall thickness of the sidewalls 12 of about 0.046 inches, the thickness of the container 10 at the flow leaders 20 is thus comprised between about 0.056 and about 0.071 inches, for example of about 0.061 inches. The flow leaders extend from the base 16 to a height along a respective sidewall 12, for example between up about the lower one of horizontal ribs 30 to just above the upper one of horizontal ribs 30, below the top opening.

Each corner 40 includes a thickness or corner portion 45 extending along at least part of a height of each corner 40 from the base 16, for example along at least ½ of the height of each corner 40, for example along at least 2/3 of the height of each corner 40, in which the corner has an increased thickness. The corner portions 45 are shown extending substantially from the base 16 to a height less than or equal to the height of the flow leaders 20 and have a thickness i.e. so that a ratio of the thickness of the corner portions 45 to the wall thickness of the sidewalls 12 is comprised between about 125% and 175%, i.e. a thickness of about 0.075 inches for example for a wall thickness of the sidewalls 12 of 0.046 inch. Each corner portion 45 has a width between less than the width (perimeter) of the respective corner 40 to a width just greater than the circumference of the respective corner 40, and tapers to smoothly join with respective sidewalls 12 without discontinuities or abrupt transactions.

As a result of the larger thickness of the corner portions 45 as compared to the thinner sidewalls 12 and top portions 47 of corners 40, during molding, the plastic material flows to form the corner portions 45 faster than the remainder of container 10, resulting in the tops of sidewalls 12 filling later than the corner portions 45. On the other hand, the flow leaders 20 along a substantial height of the sidewalls 12 provide a flow of material to the tops of the sidewalls, thereby promoting a substantially even filling of the mold.

As a result of this structure combining flow leaders along the sidewalls 12 and thicker corner portions 45 relative to the thickness of the sidewalls 12, a plastic container made can be fabricated from any plastic, such as polypropylene or the like, by way of example, with utilizing less material and thus having a reduced weight, while simultaneously having an increased top load or vertical resistance without the need for complex webbings as used in prior art containers. By way of example, a prior art plastic pail made of high density polyethylene, with a substantially constant wall thickness of 0.075 inches for example, of a weight of 660 grams, has a top load of 523 Kgf, or a prior art polypropylene pail formed with the same internal cavity with walls having a 0.062 inch thickness results in a weight of 528 grams and a top load of only 470 Kgf. In contrast thereto, a same sized pail constructed in accordance with the present invention, with a wall thickness comprised between about 0.046 and 0.075 (at the corners) inches resulting in a weight of only about 454 grams, has a top load of 550 Kgf.

The scope of the claims should not be limited by the preferred embodiments set forth in the examples, but should be given the broadest interpretation consistent with the description as a whole.

1. A container, comprising:
a base;
a plurality of sidewalls extending from the base to a top opening, adjacent sidewalls being connected together by a corner;
a plurality of flow leaders extending across the base, each flow leader extending along a surface of a respective sidewall up to a distance from the top opening, each flow leader having a thickness greater than a wall thickness of the base and a wall thickness of the respective sidewall; and
a plurality of corner portions extending along a height of a respective corner, the corner portion increasing the wall thickness of each corner to a wall thickness substantially greater than the wall thickness of the sidewalls.

2. The container of claim 1, wherein said base comprises a gate site and flow leaders, said flow leaders extending from said gate site to a respective sidewall and along a surface of each sidewall up to an upper part of each side wall.

3. The container of claim 1, wherein said base comprises a gate site and flow leaders, said flow leaders extending from said gate site to a respective sidewall and along a surface of each sidewall up to an upper part of each side wall, said flow leaders having a thickness increased relative to a wall thickness of the sidewall and the base by about 10 to 50 percent.

4. The container of claim 1, wherein said base comprises a gate site and flow leaders, said flow leaders extending from said gate site to a respective sidewall and along a surface of each sidewall and terminating in a flare in an upper part of each sidewall.

5. The container of claim 1, of a substantially rectangular footprint, wherein said base comprises a gate site and flow leaders disposed at about a 90 degree angle from one another, said flow leaders extending from said gate site to a respective sidewall and along a surface of each sidewall up to an upper part of each side wall.

6. The container of claim 1, wherein each corner portion extends along at least part of a height of each corner from the base.

7. The container of claim 1, wherein each corner portion extends along at least ½ of the height of each corner.

8. The container of claim 1, wherein each corner portion extends along at least 2/3 of the height of each corner.

9. The container of claim 1, wherein each corner portion extends along at least part of a height of each corner substantially from the base to a height less than or equal to a height of the flow leaders on the side walls.

10. The container of claim 1, wherein a ratio between the thickness of the corner portions and the wall thickness of the sidewalls is comprised between about 125% and about 175%.

11. The container of claim 1, wherein the corner portions have a width substantially equal to a width of the corners.

12. The container of claim 1, wherein each corner portion tapers to smoothly join with respective sidewalls.

13. The container of claim 1, further comprising vertical ribs extending along part of the height of the container at upper portions of the sidewalls.

14. The container of claim 1, further comprising at least one horizontal rib about at least part of upper portions of the sidewalls.

15. The container of claim 1, further comprising spaced horizontal ribs about at least part of upper portions of the sidewalls and vertical ribs at spaced intervals between said horizontal ribs.

16. The container of claim 1, wherein said base, sidewalls and corners are integrally formed with each other.

17. The container of claim 1, further comprising spaced horizontal ribs about at least part of upper portions of the sidewalls and vertical ribs at spaced intervals between said horizontal ribs, said base, sidewalls, corners, horizontal ribs, and vertical ribs being integrally formed with each other.

18. A method for molding a container, comprising:
providing a flow leader along a base and each sidewall of a mold along a height of each sidewall from the base;
providing a thickness portion at each corner of the mold; and
injecting plastic into the mold.

19. A method of forming a container, comprising:
forming a base;
forming sidewalls extending from the base;
forming corners connecting adjacent sidewalls, each corner having at least one part of a height thereof of an increased thickness relative to a wall thickness of the sidewalls; and
providing flow leaders extending across the base, each flow leader extending up along a surface of a respective sidewall, each flow leader having a thickness greater than a wall thickness of the base and a wall thickness of the respective sidewall.

20. The method of claim 19, wherein said providing flow leaders comprises providing flow leaders having a thickness increased relative to a wall thickness of the sidewall and the base by about 10 to 50 percent.

21. The method of claim 19, wherein said providing flow leaders comprises providing flow leaders terminating in a flare in an upper part of each sidewall.

22. The method of claim 19, wherein said forming a base comprises forming a base of a substantially rectangular footprint, and providing flow leaders extending across the base comprises providing flow leaders disposed at about a 90 degree angle from one another on the base.

23. The method of claim 19, wherein said forming corners comprises forming corners having at least one height thereof with a thickness such that a ratio between the thickness of the corners along the at least one height thereof to the wall thickness of the sidewalls is comprised between about 125% and about 175%.
